(19) United States
(12) Patent Application Publication
(10) Pub. No.: US 2012/0089400 A1
(43) Pub. Date: Apr. 12, 2012

(54) SYSTEMS AND METHODS FOR USING HOMOPHONE LEXICONS IN ENGLISH TEXT-TO-SPEECH

(76) Inventor: Caroline Gilles Henton, Santa Cruz, CA (US)

(21) Appl. No.: 12/898,888

(22) Filed: Oct. 6, 2010

(51) Int. Cl. G10L 13/00

(52) U.S. Cl. 704/260; 704/E13.001

(57) ABSTRACT

The present invention relates to information systems. More specifically, the present invention relates to infrastructure and techniques for improving Text-to-Speech-enabled applications.

### BACKGROUND OF THE INVENTION

The present invention relates to information systems. More specifically, the present invention relates to infrastructure and techniques for improving Text-to-Speech enabled applications.

For over sixty years personal computers have run programs that provide for text to be read aloud using synthetic speech. This ability to speak text is commonly referred to as text-to-speech (TTS). Synthetic speech can usually be generated automatically from “linguistically salient acoustic properties . . . or spoken units that are selected and controlled using computational commands.” For further details, see Clark and Henton (2003). Typically, a TTS system relies on a lexicon in which word pronunciations are entered using a proprietary coding/labeling system. As most core TTS lexicons are closed to users of the product; it cannot be edited. The core TTS lexicon may also be a large component of the size (memory footprint) of the TTS system. Any means that can be used to reduce the size of the lexicon, and make access to it more efficient or more accurate are seen as a positive improvement to the speed and accuracy of the run-time TTS system.

Accordingly, what is desired is to solve problems relating to user experiences while using Text-to-Speech-enabled applications, some of which may be discussed herein. Additionally, what is desired is to reduce drawbacks related to Text-to-Speech-enabled applications, some of which may be discussed herein.

### BRIEF SUMMARY OF THE INVENTION

The present invention relates to information systems. More specifically, the present invention relates to infrastructure and techniques for improving Text-to-Speech-enabled applications.

In various embodiments, methods, systems, apparatuses, means, and computer-readable media encoded with program code are provided for selecting spoken units from a text-to-speech system lexicon that is indexed and labeled to make use of the many homophones that exist in varieties of English.

A further understanding of the nature of and equivalents to the subject matter of this disclosure (as well as any inherent or express advantages and improvements provided) should be realized by reference to the remaining portions of this disclosure, any accompanying drawings, and the claims in addition to the above section.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 illustrates an information system that may incorporate embodiments of the present invention.

FIG. 2 is a flowchart of a method for converting text to speech in one embodiment according to the present invention.

FIG. 3 is a flowchart of a method for linguistic morphological analysis in one embodiment according to the present invention.

FIG. 4 is a block diagram of a computer system or information processing device that may be used to implement or practice various embodiments of an invention whose teachings may be presented herein.

### DETAILED DESCRIPTION OF THE INVENTION

The present invention relates to information systems. More specifically, the present invention relates to infrastructure and techniques for improving Text-to-Speech-enabled applications.

The following terms and phrases may be used throughout the disclosure:
Text-to-Speech (TTS): Hardware and/or software elements configured for translating text into audio output that simulates human speech.

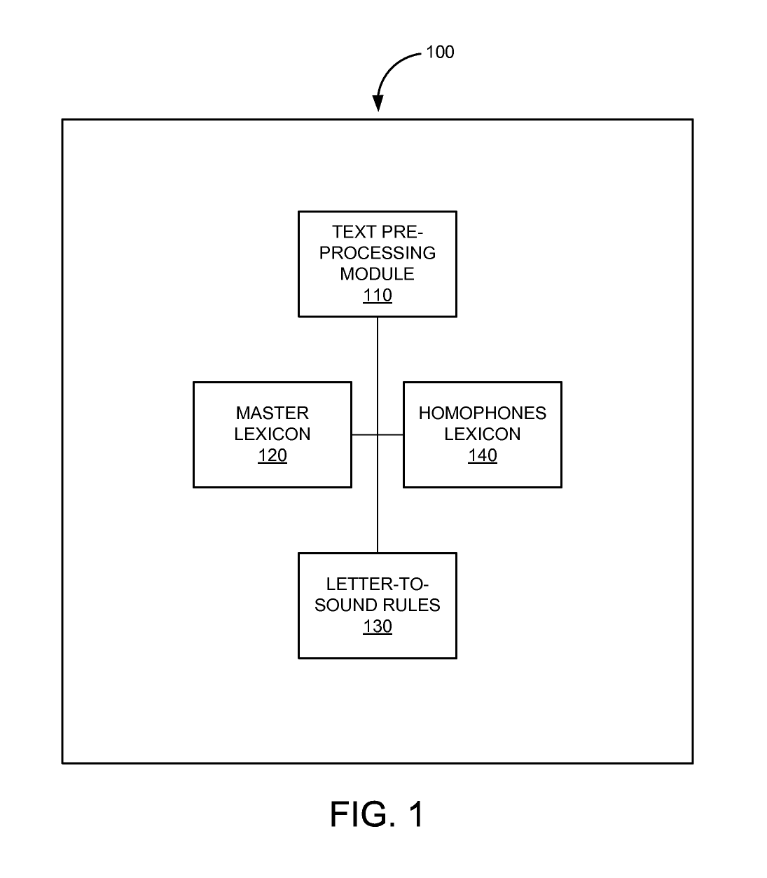

FIG. 1 illustrates information system 100 that may incorporate embodiments of the present invention. In this example, system 100 includes text pre-processing module 110, master lexicon 120, letter-to-sound rules 130, and homophones lexicon 140. In various embodiments, system 100 outputs information to users in audible form that simulates human speech and provides for selecting spoken units from a text-to-speech system lexicon that is indexed and labeled to make use of the many homophones that exist in varieties of English.

### Homophones

One definition of a homophone is a word that is pronounced the same as one or more other words, but differs in its spelling, e.g., air/heir/ere; sticks and Styx. The ‘same’ pronunciation means identical in both phonetic characters, and in word stress (accent). Thus ‘august’ (adjective) and ‘August’ (noun) are not homophones because the adjectival form is stressed on the second syllable, and the stress is on the first syllable for the month. Similarly, ‘absent’ (adjective) and ‘absent’ (verb) are not homophones. Such orthographically identical pairs are homographs (written the same way, but pronounced differently).

In an extensive survey of American (US) English homophones and homographs, Hobbs (1993) lists 7,149 homophones in US English. But, most importantly from the perspective of this invention, Hobbs (1993, p. 5) excluded the following classes of words:

obsolete, archaic and rarely used words

words associated with regional dialects

most colloquialisms

proper names, such as Claude/clawed

most foreign units of money, weights and measures

In various embodiments, system 100 can include proper names, business names, product names, and foreign units of money, weights and measures etc. in a specific lexicon for cross-referencing homophonous common words and proper names (names) for use in a TTS system.

Linguistic Components of a TTS System

In various embodiments, system 100 contains linguistic modules that can be used to determine the pronunciation(s) of words. These may include, inter alia:

1. Text pre-processing module 110 that includes hardware and/or software elements that detect, remove or reinterpret spurious characters, non-lexical items, abbreviations, acronyms and punctuation.

2. Master lexicon 120 that includes hardware and/or software elements that contain common words and regular morphological root forms; the latter may be used to predict pronunciation of derived forms. Master lexicon 120 serves as a knowledge base for predicting word classes (parts of speech) and word stress patterns.

3. Letter-to-sound rules 140 that includes hardware and/or software elements that may be used to create pronunciations for words that are not handled well by text pre-processing module 110 and master lexicon 120 above.

Modules 110 and 120 can act in unison to detect the difference between common words and proper nouns. The class of proper nouns in English includes toponyms, city and street names, personal names, and business listings. There are many hundreds of thousands of toponyms, city and street names. The number of personal names and business listings is potentially infinite; see Henton (2003) for an overview of the pitfalls this presents to speech technology, particularly for any TTS system.

In English, neologisms abound and increase daily because it is possible to invent personal names, business listings and product names at will, as long as they conform to the orthographic, phonologically combinatorial, and pronunciation rules of English (e.g., a female name, ‘LaShawnda Starface’; an apparel business listing, ‘BeauTyz’; a product ‘NuysKreme’). Unlike France, no English-speaking country has an official, governmental office (cf. L'Académie Française) that dictates which first names can be given to children.

In English text, it is relatively easy to detect proper nouns (Names) because they are written with an initial upper case letter, and if the spelling is the same as a common word (e.g., brown and Brown), then the proper noun will be pronounced correctly. Problems can arise however when one of the following variations occur:

1. Names that have spelling variations:
e.g., Maguire, MacGuire, McGuire, McGwyer
e.g., Mindie, Mindy, Mindhi

2. Common words and Names are spelt differently, but are pronounced the same:
e.g., forty, Forte
e.g., green, Greene

3. The contracted form of two words is pronounced the same as the full form of one word:
e.g., I'll, aisle, isle
e.g., I'd, ide
e.g., where's, wears
e.g., who's, whose
e.g., you're, your, yore

With regard to point 3 above, the substitutability of one form for the other will depend on the accuracy of the text preprocessor, so that the apostrophes are ‘removed’, and disregarded for the purposes of pronunciation. However, without sophisticated parsing of the whole utterance to be synthesized, it may prove counter-productive to better perceptual quality, intelligibility and naturalness if one of these contracted forms is substituted for another form. The two words (e.g., ‘your’ and ‘yore’) have different parts of speech (PoS); so substituting the former possessive pronoun for the latter adjective may detract from the perceived quality of the TTS if the token for “your” has been selected from an utterance where it was spoken in the reduced, or weak form, ‘yer’.

Using linguistic and phonetic knowledge, a (sub-) lexicon of homophones can be included in a TTS engine (e.g., homophones lexicon 140). When a ‘new’ word is encountered in a string of text, master lexicon 120 is checked to see whether that word exists in the lexicon. If it is present, then it will be pronounced correctly. If it is not present, then it should be submitted to homophones lexicon 140. If a homophone is present, then the new word can be pronounced correctly by its phonetic ‘double’ (e.g., ‘young’ for ‘Yung’; ‘melon’ for ‘Mellon); the common word is more likely to have been spoken or recorded in a speech database (corpus) than is the name. The obvious advantage to this approach is that many redundant entries can be avoided in master lexicon 120, saving human entry time, disk/memory space, and run-time look-up and concomitant speed.

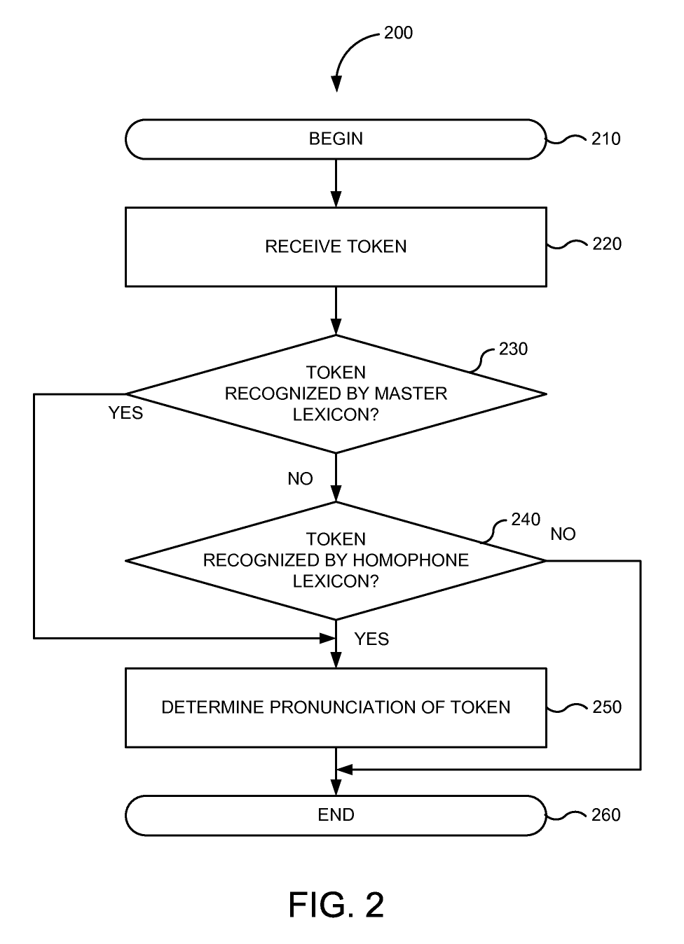

FIG. 2 is a flowchart of method 200 for converting text to speech in one embodiment according to the present invention. Implementations of or processing in method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, a token is received. In various embodiments, one or more terms, words, phrases, etc. represented by the token may be generated after one or more documents are tokenized. For example, textual information extracted from or otherwise obtained from the one or more text documents may processed by text pre-processing module 110 to detect, remove, or otherwise reinterpret spurious characters, non-lexical items, abbreviations, acronyms, punctuation, or the like. In other embodiments, one or more terms, words, phrases, etc. represented by the token may be obtained in real time from one or more data packets, emails, text messages, or the like.

In step 230, a determination is made whether the token is recognized by a central or master lexicon. For example, central or master lexicon 120 may contain common words and regular morphological root forms. These morphological root forms may be used to predict pronunciation of derived forms. Central or master lexicon 120 may further serve as a knowledge base for predicting word classes (parts of speech) and word stress patterns.

If a determination is made in step 230 that the token is recognized by the central or master lexicon, the central or master lexicon is to determine pronunciations of one or more terms, words, phrases, etc. represented by the token. For example, if a match is contained in master lexicon 120 for one or more terms, words, phrases, etc. represented by the token, master lexicon 120 is used to determine the pronunciation of the one or more terms, words, phrases, etc. represented by the token. If a determination is made in step 230 that the token is not recognized by the central or master lexicon, a determination can be made whether the token is recognized by one or more additional lexicons of homophones. For example, in step 240, a determination is made whether the token is recognized by a homophones lexicon. For example, homophones lexicon 140 contains homophone (e.g., phonetic ‘doubles’ of some common words and regular morphological root forms). If a homophone is present in homophone lexicon 140 for the token, homophones lexicon 140 is used to determine the pronunciations for one or more phonetic doubles for any of one or more terms, words, phrases, etc. represented by the token.

In step 250, pronunciation of the token is determined. For example, if a match is present in master lexicon 120 for the token, master lexicon 120 is used to determine pronunciation of one or more terms, words, phrases, etc. represented by the token. In another example, if a match is present in homophones lexicon 140 for the token, homophones lexicon is used to determine pronunciation of one or more terms, words, phrases, etc. represented by the token. In yet another example, if a match is not found in master lexicon 120 and a homophone is not present in homophones lexicon 140 for at least one of one or more terms, words, phrases, etc. represented by the token, letter-to-sound rules 130 can be used in determination of pronunciations for at least one of the terms, words, phrases, etc. represented by the token.

In some aspects, pronunciation of any of the terms, words, phrases, etc. represented by the token may be determined all or in part by each of master lexicon 120, homophones lexicon 130, and letter-to-sound rules 130. In one example, at least part of the pronunciation may be determined by master lexicon 120 and at least another part may be determined by homophones lexicon 140. In another example, complete pronunciation of all terms, words, phrases, etc. represented by the token may be determined using a combination of master lexicon 120, homophones lexicon 140, and letter-to-sound rules 130.

Accordingly, in some aspects, many redundant entries can be avoided in the central or master lexicon, saving human entry time, disk/memory space, and run-time look-up and concomitant speed. FIG. 2 ends in step 260.

In various embodiments, the one or more homophone lexicons can be region/dialect independent for each language. For example, there are different spelling and pronunciation conventions that exist in the various English-speaking regions. In some embodiments, the one or more homophone lexicons can be adapted to a list of homophones to account for sub-continental regional dialectal or accentual variants. In sociolinguistic and dialectal descriptions of US English document certain categories of words that are distinct in one dialect, but which may collapse that distinction in another dialect. For example, the vocalization of /l/, which causes the distinction between ‘Al, owl, oil’ to collapse in the speech of some Pittsburgh natives; and the collapse of the distinctions between ‘Mary, merry, marry, Murray’ by speakers in the North East of the US. There are also a smaller number of cases where the ‘standard’ American English pronunciation merges words that are kept separate in some American dialects, for example ‘horse/hoarse’; ‘four/for’; ‘her/Hur’, etc. (Liberman (1996) p.c.) Similarly, a homophone lexicon should not have to account for apparent homophones in dialects where, for example, the phonetic behavior of vowel-raising and diphthongization before /n/ combine to merge e.g., ‘aunt’ and ‘ain't; ‘can’ and ‘cane’, etc.

In further embodiments, the one or more homophone lexicons can be further optimized by not accounting for common, accepted, pronunciation variants for words such as ‘economic’ and ‘controversy’. In another aspect, the one or more homophone lexicons may be optimized to not include non-language pronunciation variants, e.g., Jesus/j ee z u s/vs. Jesus/h ey z oo s/(Spanish personal name).

In some aspects, contents of one US English homophone lexicon can be different from the homophone lexicons for the major inter-continental varieties of English: UK English, Canadian English, Australian/New Zealand English, South African English, Indian English, etc. There will be some, but not complete, overlap in the Names that will be entered as part of the homophone lexicons for all varieties of English, but each will have to take account of the differing spelling conventions in those varieties; e.g., US Marlboro vs. UK Marlborough.

A preliminary lexicon of homophones for UK English (assembled, but not published, by the inventor) contains 440 entries to date, excluding Names. Common phonetic differentiators between US English and UK English (notably ‘r-lessness’ in Southern UK English) will occasion different types, and greater numbers, of homophones in UK English where, e.g., ‘Dawn/Dorn; ‘saw/sore’, ‘law/lore’, ‘Anthony/Antony’, are all homophonous pairs.

### Morphological Components

A linguistic morphological analysis of common affixes in Names can further prove beneficial in reducing the size of a TTS system's core lexicon, and in pronouncing new Names more accurately. It is possible to label common affixes (the combined class of prefixes and suffixes) and ‘strip’ them, so that they can be used as ‘independent’ pronunciation units, or word building blocks. Thus, using the example of Marlboro vs. Marlborough above, it is possible to ‘strip’ both ‘-boro’ and ‘-borough’ and to cross-reference them both so that the entries will be pronounced in the same way. The same approach can be used for the common ‘allomorphs’ in the spelling of Names such as ‘Jordan, Jorden, Jordin, Jordon’, and ‘Jordun’; Larsen/Larson, etc. Because the first syllable of the name is stressed, the second syllable will be pronounced the same way, regardless of which spelling variant appears in the second syllable.

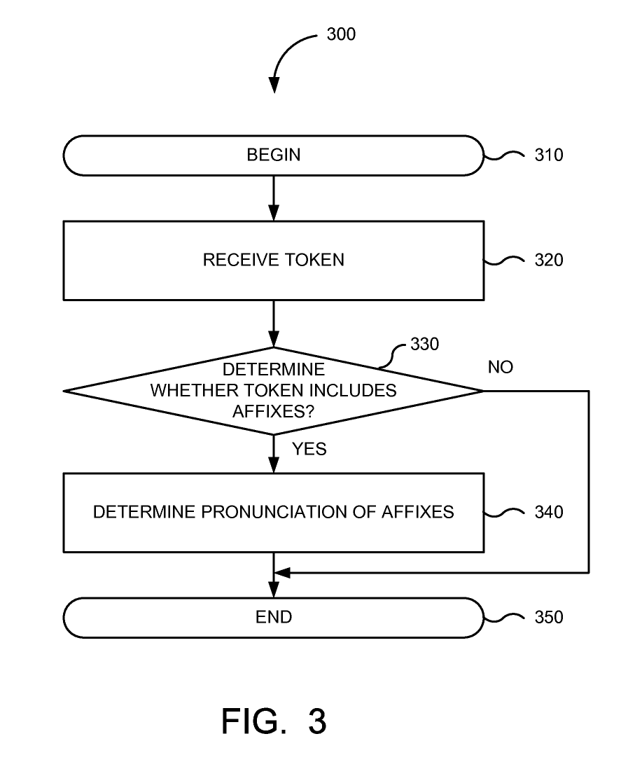

FIG. 3 is a flowchart of method 300 for linguistic morphological analysis in one embodiment according to the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

In step 320, a token is received. In step 330, a determination is made whether the token includes one or more affixes. For example, text pre-processing module 110 may determine one or more predetermined affixes associated with the token. In general, a predetermined affix can include one or more in a class of prefixes and suffixes. Each predetermined affix may be used as an ‘independent’ pronunciation unit or word building block to determine pronunciation of the entire token.

In step 340, if it is determined that the token includes one or more affixes, pronunciation of the one or more affixes may be determined pronounced as illustrated in FIG. 2. For example, a determination may be made whether each of the one or more affixes is recognized by at least one of the master lexicon 120, homophones lexicon 140, and letter-to-sound rules 140. Additionally, pronunciation of any remaining potion of the token may also be determined as illustrated in FIG. 2. FIG. 3 ends in step 350.

In various embodiments, the same suffix-stripping method may also be applied to account for the ‘doubling’ of suffixes, e.g., cadet/cadette; program/programme, and other common US/UK spelling variations: labeling/labelling; traveler/traveller; color/colour, etc. See Henton (2001) for a complete list of such variants.

Such affix-stripping might be applied recursively, so that new words can be generated and pronounced correctly by means of morphological agglomeration. For example, ‘-stern’, ‘-ston’, and ‘-burg’ are common suffix morphemes in Names; ‘New-’, ‘Morgen-’, and ‘Ash-’ are common prefix morphemes in Names. Using the affix-stripping method, it would be possible to generate correct pronunciations for Names that are not yet in the lexicon, but which comprise known Name affix morphemes to create and pronounce correctly, e.g., ‘Newstern, Morgenston, Newburg, Ashston’, etc.

Morphological analysis can furthermore prove an asset in dynamically generating pronunciations for product or model names. For example, the Sony ‘Bravia’ would be analyzed for its component morphemes ‘bra’+‘via’ and pronounced correctly, according to the pronunciations in the lexicon for those two words, as opposed to an incorrect pronunciation ‘brave’+‘ia’. Similarly, the car model ‘Escalade’ would be pronounced correctly by affix-stripping and morphological analogy with ‘escal-’ (from ‘escalate’) and ‘-ade’ (from ‘lemonade’).

In further embodiments, one or more homophone lexicons for US English may further contain the common spelling variants between varieties of English, e.g., US ‘center’ vs. UK ‘centre’, and US ‘recognize’ vs. UK ‘recognise’. For further details on the rules needed to convert US to UK spelling, see Henton (2001). In general, the non-US varieties of English (Australian, Canadian, Indian) follow the UK English spelling conventions.

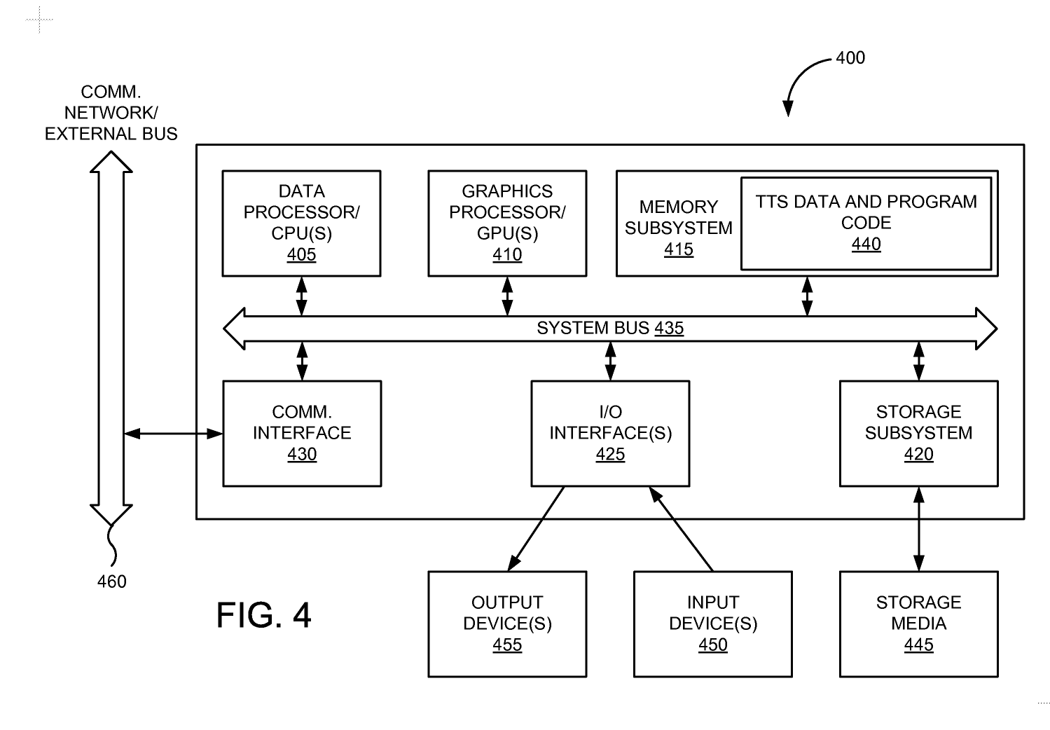

FIG. 4 is a block diagram of computer system 400 that may be used to implement or practice various embodiments of an invention whose teachings may be presented herein. FIG. 4 is merely illustrative of a computing device, general-purpose computer system programmed according to one or more disclosed techniques, or specific information processing device for an embodiment incorporating an invention whose teachings may be presented herein and does not limit the scope of the invention as recited in the claims. One of ordinary skill in the art would recognize other variations, modifications, and alternatives.

Computer system 400 can include hardware and/or software elements configured for performing logic operations and calculations, input/output operations, machine communications, or the like. Computer system 400 may include familiar computer components, such as one or more one or more data processors or central processing units (CPUs) 405, one or more graphics processors or graphical processing units (GPUs) 410, memory subsystem 415, storage subsystem 420, one or more input/output (I/O) interfaces 425, communications interface 430, or the like. Computer system 400 can include system bus 435 interconnecting the above components and providing functionality, such connectivity and inter-device communication. Computer system 400 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 405 can include hardware and/or software elements configured for executing logic or program code or for providing application-specific functionality. Some examples of CPU(s) 405 can include one or more microprocessors (e.g., single core and multi-core) or micro-controllers, such as PENTIUM, ITANIUM, or CORE 4 processors from Intel of Santa Clara, Calif. and ATHLON, ATHLON XP, and OPTERON processors from Advanced Micro Devices of Sunnyvale, Calif. CPU(s) 405 may also include one or more field-gate programmable arrays (FPGAs), application-specific integrated circuits (ASICs), or other microcontrollers. The one or more data processors or central processing units (CPUs) 405 may include any number of registers, logic units, arithmetic units, caches, memory interfaces, or the like. The one or more data processors or central processing units (CPUs) 405 may further be integrated, irremovably or moveably, into one or more motherboards or daughter boards.

The one or more graphics processor or graphical processing units (GPUs) 410 can include hardware and/or software elements configured for executing logic or program code associated with graphics or for providing graphics-specific functionality. GPUs 410 may include any conventional graphics processing unit, such as those provided by conventional video cards. Some examples of GPUs are commercially available from NVIDIA, ATI, and other vendors. In various embodiments, GPUs 410 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 410 may include any number of registers, logic units, arithmetic units, caches, memory interfaces, or the like. The one or more data processors or central processing units (CPUs) 405 may further be integrated, irremovably or moveably, into one or more motherboards or daughter boards that include dedicated video memories, frame buffers, or the like.

Memory subsystem 415 can include hardware and/or software elements configured for storing information. Memory subsystem 415 may store information using machine-readable articles, information storage devices, or computer-readable storage media. Some examples of these articles used by memory subsystem 470 can include random access memories (RAM), read-only-memories (ROMS), volatile memories, non-volatile memories, and other semiconductor memories. In various embodiments, memory subsystem 415 can include TTS data and program code 440.

Storage subsystem 420 can include hardware and/or software elements configured for storing information. Storage subsystem 420 may store information using machine-readable articles, information storage devices, or computer-readable storage media. Storage subsystem 420 may store information using storage media 445. Some examples of storage media 445 used by storage subsystem 420 can include floppy disks, hard disks, optical storage media such as CD-ROMS, DVDs and bar codes, removable storage devices, networked storage devices, or the like. In some embodiments, all or part of TTS data and program code 440 may be stored using storage subsystem 420.

In various embodiments, computer system 400 may include one or more hypervisors or operating systems, such as WINDOWS, WINDOWS NT, WINDOWS XP, VISTA, or the like from Microsoft of Redmond, Wash., Mac OS X from Apple Inc. of Cuptertina, Calif., SOLARIS from Sun Microsystems of Santa Clara, Calif., LINUX, UNIX, and UNIX-based operating systems. Computer system 400 may also include one or more applications configured to executed, perform, or otherwise implement techniques disclosed herein. These applications may be embodied as TTS data and program code 440. Additionally, computer programs, executable computer code, human-readable source code, or the like, and data may be stored in memory subsystem 415 and/or storage subsystem 420.

The one or more input/output (I/O) interfaces 425 can include hardware and/or software elements configured for performing I/O operations. One or more input devices 450 and/or one or more output devices 455 may be communicatively coupled to the one or more I/O interfaces 425.

The one or more input devices 450 can include hardware and/or software elements configured for receiving information from one or more sources for computer system 400. Some examples of the one or more input devices 450 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 450 may allow a user of computer system 400 to interact with one or more non-graphical or graphical user interfaces to enter a comment, select objects, icons, text, user interface widgets, or other user interface elements that appear on a monitor/display device via a command, a click of a button, or the like.

The one or more output devices 455 can include hardware and/or software elements configured for outputting information to one or more destinations for computer system 400. Some examples of the one or more output devices 455 can include a printer, a fax, a feedback device for a mouse or joystick, external storage systems, a monitor or other display device, a communications interface appropriately configured as a transceiver, or the like. The one or more output devices 455 may allow a user of computer system 400 to view objects, icons, text, user interface widgets, or other user interface elements.

A display device or monitor may be used with computer system 400 and can include hardware and/or software elements configured for displaying information. Some examples include familiar display devices, such as a television monitor, a cathode ray tube (CRT), a liquid crystal display (LCD), or the like.

Communications interface 430 can include hardware and/or software elements configured for performing communications operations, including sending and receiving data. Some examples of communications interface 430 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 430 may be coupled to communications network/external bus 480, such as a computer network, to a FireWire bus, a USB hub, or the like. In other embodiments, communications interface 430 may be physically integrated as hardware on a motherboard or daughter board of computer system 400, may be implemented as a software program, or the like, or may be implemented as a combination thereof.

In various embodiments, computer system 400 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 400.

As suggested, FIG. 4 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may techniques described above as implemented upon a chip or an auxiliary processing board.

Various embodiments of any of one or more inventions whose teachings may be presented within this disclosure can be implemented in the form of logic in software, firmware, hardware, or a combination thereof The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

### REFERENCES

CLARK, J. E. and HENTON, C. G. (2003). Speech Synthesis. In William J. Frawley, (ed.) International Encyclopaedia of Linguistics. 4nd. edition. Oxford, Oxford University Press. Volume 4, pp. 157-162.

HENTON, C. (2003). The name game. Pronunciation Puzzles for TTS. Speech Technology, September-October: 32-35.

HENTON, C. G. (2001) Method and Apparatus for Automatic Internationalization and Localization for UK English Language. Patent application with US Patent Office.

HOBBS, J. B. (1993) Homophones and Homographs. An American Dictionary. 4nd. edition. Jefferson, N.C., McFarland.

LIBERMAN, M. (1996) Personal communication.

What is claimed is:

1. A method for providing text-to-speech comprising:
receiving, at one or more computer systems, a master lexicon;
receiving, at the one or more computer systems, a lexicon of homophones;
receiving, at the one or more computer systems, textual information having at least one token;
determining, with one or more processors associated with the one or more computer systems, pronunciation of the token based on a homophone of the token in the lexicon of homophones when the token is not recognized by the master lexicon; and
outputting the determined pronunciation of the token using an output device associated with the one or more computer systems.

2. The method of claim 1 wherein determining the pronunciation of the token based on a homophone of the token in the lexicon of homophones when the token is not recognized by the master lexicon comprises using a homophone lexicon that is region/dialect independent for English.

3. The method of claim 1 further comprising:
determining, with the one or more processors associated with the one or more computer systems, one or more predetermined affixes associated with the token; and
determining, with the one or more processors associated with the one or more computer systems, pronunciation of the one or more predetermined affixes using the master lexicon or the lexicon of homophones.

4. The method of claim 3 wherein determining, with the one or more processors associated with the one or more computer systems, the one or more predetermined affixes associated with the token comprises determining one or more prefixes associated with the token.

5. The method of claim 3 wherein determining, with the one or more processors associated with the one or more computer systems, the one or more predetermined affixes associated with the token comprises determining one or more suffixes associated with the token.

6. The method of claim 3 wherein determining, with the one or more processors associated with the one or more computer systems, the one or more predetermined affixes associated with the token comprises determining one or more component morphemes associated with the token.

7. A non-transitory computer-readable medium storing computer-executable code for providing text-to-speech, the computer-readable medium comprising:
code for receiving a master lexicon;
code for receiving a lexicon of homophones;
code for receiving textual information having at least one token; and
code for determining pronunciation of the token based on a homophone of the token in the lexicon of homophones when the token is not recognized by the master lexicon.

8. The computer-readable medium of claim 7 wherein the code for determining the pronunciation of the token based on a homophone of the token in the lexicon of homophones when the token is not recognized by the master lexicon comprises code for using a homophone lexicon that is region/dialect independent for English.

9. The computer-readable medium of claim 7 further comprising:
code for determining one or more predetermined affixes associated with the token; and
code for determining pronunciation of the one or more predetermined affixes using the master lexicon or the lexicon of homophones.

10. The computer-readable medium of claim 9 wherein the code for determining the one or more predetermined affixes associated with the token comprises code for determining one or more prefixes associated with the token.

11. The computer-readable medium of claim 9 wherein the code for determining the one or more predetermined affixes associated with the token comprises code for determining one or more suffixes associated with the token.

12. The computer-readable medium of claim 9 wherein the code for determining the one or more predetermined affixes associated with the token comprises code for determining one or more component morphemes associated with the token.

13. A system for providing text-to-speech, the system comprising:
a processor; and
a memory in communication with the processor and configured to store processor-executable instructions that configure the processor to:
receive a master lexicon;
receive a lexicon of homophones;
receive textual information having at least one token;
determine pronunciation of the token based on a homophone of the token in the lexicon of homophones when the token is not recognized by the master lexicon; and
output the determined pronunciation of the token using an output device.

14. The system of claim 13 wherein to determine the pronunciation of the token based on a homophone of the token in the lexicon of homophones when the token is not recognized by the master lexicon the processor is configured to use a homophone lexicon that is region/dialect independent for English.

15. The system of claim 13 wherein the processor is further configured to:
determine one or more predetermined affixes associated with the token; and
determine pronunciation of the one or more predetermined affixes using the master lexicon or the lexicon of homophones.

16. The system of claim 15 wherein to determine the one or more predetermined affixes associated with the token the processor is configured to determine one or more prefixes associated with the token.

17. The system of claim 15 wherein to determine the one or more predetermined affixes associated with the token the processor is configured to determine one or more suffixes associated with the token.

18. The system of claim 15 wherein to determine the one or more predetermined affixes associated with the token the processor is configured to determine one or more component morphemes associated with the token.
